(19) United States
(12) Patent Application Publication
(10) Pub. No.: US 2020/0060927 A1
(43) Pub. Date: Feb. 27, 2020

(54) ADJUSTABLE MUSCLE MASSAGE BOARD

(71) Applicants: Nathaniel Charles Bailey, Athol, ID (US); Michelle M Bailey, Athol, ID (US)

(72) Inventors: Nathaniel Charles Bailey, Athol, ID (US); Michelle M Bailey, Athol, ID (US)

(21) Appl. No.: 16/548,245

(22) Filed: Aug. 22, 2019

Related U.S. Application Data
(60) Provisional application No. 62/722,668, filed on Aug. 24, 2018.

(51) Int. Cl. A61H 15/00

(52) U.S. Cl. CPC A61H 15/00; A61H 2201/0123; A61H 2201/0126; A61H 2205/081; A61H 2015/0028; A61H 2201/1253; A61H 2205/04; A61H 2201/0192

(57) ABSTRACT

An adjustable muscle massage device which may be hung or mounted on a suitable support structure, such as a door or wall. One embodiment is a system comprising a massage platform with one or more massage components, adjustment levers to allow adjustment of the massage device relative to the user or support structure, and hangers to attach the device to the support structure. The massage platform, when mounted and properly adjusted, supports the massage component(s) which allows the user to lean against the massage component(s) and move against them to provide massaging action for the desired areas. The adjustment feature allows a wide range of areas to be massaged in this fashion. One advantage is the user may utilize this device hands free while standing or leaning against it, rather than being forced to sit or lie down to use the device.

### CROSS-REFERENCE TO RELATED PATENT APPLICATION

The present application claims priority from Provisional Patent Application No. 62/722,668

### FIELD OF THE INVENTION

The present invention relates to therapeutic body massage devices, and more particularly, a board or similar platform which can be hung or mounted on a door, wall or other suitable surface, and is easily adjustable in height for various users, including many people with limiting injuries or handicaps, from which one or more massage elements protrude.

### BACKGROUND ART

Current massage devices fall generally into one of seven categories, and current designs present problems which create difficulties of usage or expense which inhibits broad usability. The simplest are non-motorized hand-held devices, hand-held rods, sticks or “shepherd hook” style devices, which have the advantage of being relatively cheap and easy to manufacture and simple to use for certain applications. They are typically portable, lightweight and take up little room. However rods, sticks and shepherd hook style devices require good flexibility, upper body strength and hand strength on the part of the user, especially in order to address muscle tightness in the areas of the back or lower neck. This dramatically limits their usefulness for anyone with reduced strength or flexibility, or those with injuries or other handicaps that affect upper body or hand capabilities. This limits their usefulness for a large portion of people who most need relief of muscle tension.

The second broad category is the hand-held motorized type, which has the advantage that the vibrating action can help loosen muscles deeper than many simple unmotorized hand-held devices. Unfortunately, they are more expensive and difficult to manufacture, and they still suffer from the need for good flexibility and upper body strength to address back or lower neck areas, especially upper back areas. Additionally, they are typically heavier, requiring good hand strength. Due to the required flexibility, upper body strength and hand strength they are not a good candidate for individuals with injuries or handicaps that affect upper body or hand strength or flexibility. Again, this limits their usefulness for those who need them the most. They also tend to break more easily than their mechanically simpler hand-held counterparts. Finally, they require an electrical power source, which must be taken into consideration when using.

The third broad category are massage devices built into or attached to chairs. These have the advantage of not requiring upper body strength or flexibility to address areas of the back or lower neck. Thus they are a good choice for those with limited mobility or other limiting injuries or handicaps. Unfortunately, they are almost universally the most expensive option, often by orders of magnitude, placing them financially out of reach of many if not most people. They are the most complicated thus most likely to break or have serious functional problems. They are also the least portable, and in the case of those built into a chair, require more than one person to move. These devices are usually the least adjustable. And, like the hand-held motorized category, they require a power source, thus limiting their portability and usefulness.

The fourth broad category are devices, rollers, platforms or boards with massage components that are set on the floor, in which case the user lies down on the device and slides or moves in order to actuate the massaging action. Devices in this category have an advantage in that they are generally portable, relatively simple and typically don't require electrical power. Also, they are relatively effective at reaching areas of the back muscles that are difficult to massage with hand-held devices. Unfortunately in order to utilize them a user has to get down on the floor, which can be difficult for many people. Using them can be exhausting, similar to performing aerobic exercise such as sit-ups or push-ups, again restricting their use to people in decent physical shape without limiting injuries or handicaps. This limits their usefulness for many people who need them the most. There is no real way to adjust pressure used, as it is largely dependent on body weight, which can make them difficult or impossible to use for heavy or overweight individuals. They also require a reasonably clean area on the floor and suitable clothing, restricting when and where they can be used.

A fifth broad category are wearable vibrating electrically powered massage devices and wearable devices with massage components that move around to perform the massaging action. These have the advantage of being lighter and more portable than a massage chair, as well as much more affordable. They also have the advantage over hand-held vibrating massage devices in that they don't generally require much hand strength or upper body strength, and thus can used by individuals with hand injuries or many other limiting injuries or handicaps. Unfortunately these devices are usually extremely limited in range of massage area and function. The ability to adjust pressure is usually very limited, and like the massage chair and hand-held massage devices, the wearable electrically powered devices suffer from the need for some sort of an electrical power source. This can be supplied by batteries, in which case massaging strength is limited, as is the time it can be used before the batteries need replaced or recharged. The power source can optionally be line power provided by a wall outlet, in which case the device is not restricted in strength by the power supply, and the run-time is indefinite so long as standard line power is available. However, a device powered by standard household electricity suffers from the same portability issues as the hand-held electrically powered massage devices and powered massage chairs in that you are limited to using them where there is a readily available electrical power source. Finally, these devices are difficult to use for individuals with more severe hand or arm injuries and disabilities, in that they usually require both hands to effectively attach them to your body and to correctly adjust them to address the desired area. These individuals would need a second individual to attach them and adjust them for the user, which limits their usefulness. With the large number of restrictions and the lack of flexibility, these devices fall short of being useful general purpose massage tools.

The sixth broad category are those which would be hung on a door or wall, or mounted on a door, wall or similar structural backstop. This would include devices, rollers, balls, or other components hung with ropes or frames which one could lean against and slide or move against to actuate the massaging action. Devices in this category have the advantage that they require minimal upper body strength, hand strength and flexibility; and thus can be used by those with injuries or handicaps, so long as the individual can stand and lean against the device with sufficient mobility to move or slide against it. Pressure can be adjusted by how hard one leans against the device, they take up little room, can be made easily portable, and don't require special clothing in order to utilize them. These types of devices would seem to have the most promise for being widely usable and effective, but they appear to be the least developed of the possible options. Most are simple rollers or balls on ropes or rods that aren't particularly easy to adjust and don't adapt comfortably to various body types or areas. Current offerings in this category consistently fall short of sufficiently relieving muscle tension or tightness, let alone being useful for more targeted pressure point work or other tasks desirable with massage tools.

The seventh broad category are massage devices on stands, and there are few examples of these. They seem to be primarily limited by the inherent instability and structural weakness with the stand. Furthermore they are rather large and bulky compared with other options, with the exception of massage chairs, limiting the portability of such devices.

The prior art referenced above is listed below, by paragraph section in which the device class is mentioned. Note that only a couple canonical examples for each general category are listed below. The number of patents on massage devices is enormous and could easily fill a large book, just with the patent reference numbers and patent names. The prior art research done is reasonably in depth but is far from exhaustive, as an exhaustive investigation could take years of labor hours. Instead, research was focused on available products in the market, and the more popular devices were chosen as the canonical examples for each category. However, in some cases, the patents cited are not in production or widely available. In these cases, the patents were chosen as they were the first or best example (that we could find) of a significant development in the technology. The patents referenced are as follows:
Section [0003]: U.S. Pat. No. 6,093,159—FREELY ROTATIONAL MANUAL BODY MASSAGER
   Patent No.: U.S. Pat. No. D750,796S—CANE SHAPED MASSAGING TOOL
   Patent No.: U.S. Pat. No. D742,534 S—S SHAPED MASSAGING TOOL
Section [0004]: Patent No.: U.S. Pat. No. 6,682,496 B1—DEEP MUSCLE STIMULATOR DEVICE
   Patent No.: U.S. Pat. No. 5,716,332—BODY MASSAGER
Section [0005]: Pub. No.: US 2015/0297441 A1—MASSAGE CHAIR HAVING CURVED TRACK
Pub. No.: US 2008/0009777 A1—MASSAGE CHAIR MECHANISM
Patent No.: U.S. Pat. No. 5,460,598—POLYFUNCTIONAL AUTOMATIC MASSAGER OF CHAIR TYPE
Section [0006]: Patent No.: U.S. Pat. No. 4,374,519—SPINAL MASSAGE DEVICE
Section [0007]: Pub. No.: US 2009/0118652 A1—NECK MASSAGING DEVICE
   Pub. No.: US 2008/0195006 A1—MASSAGING DEVICE
   Pub. No.: US 2004/0267173 A1—BATTERY OPERATED FLEXIBLE MASSAGE TUBE
Section [0008]: Patent No.: U.S. Pat. No. 5,913,839—BALL-MASSAGING BOARD
Section [0009]: Pub. No.: US 2016/0338901 A1—MASSAGING BOARD ASSEMBLY

All of the cited devices researched and mentioned in Sections [0003]-[0009] suffer from serious usability restrictions and limits, excessive cost barriers, unrealistic physical strength requirements, unrealistic physical capability requirements or a combination of these. One could argue that the large proliferation of patents regarding massage devices demonstrates that the current offerings are not addressing the primary needs of the users of such devices.

### SUMMARY OF THE EMBODIMENTS

A massage device in the form of a platform assembly is provided, which can be hung or mounted on a door or wall, with one or more pivoting casters, rollers, or other protrusion acting as the massaging components. The method of attaching the device comprises a hanging mechanism for the platform assembly which can be directly mounted to a door or wall or can be attached via a set of rods, rails, tubes or straps that hang over the backing platform, such as a door. The platform is to be easily adjustable in height off the floor to accommodate different users or use cases. In particular, it is designed to be easily usable by individuals with back problems, hand problems, wrist problems, missing portions of hands or arms, or other physical limitations—so long as the user is able to stand to lean against the assembly and move enough to actuate the massaging action. Also, it is designed to be used with little or no preparation, without requiring special clothing and without requiring additional space. This is accomplished by function of adjustment handles, levers or knobs that actuate a locking or clamping mechanism to fix the platform at the desired height along the hanger rods, rails, tubes or straps and release it to allow height adjustment when desired. In the case that the platform assembly is not permanently mounted, the hangers or mounting straps are designed to allow the assembly to be easily removed and/or transported.

### BRIEF DESCRIPTION OF THE DRAWINGS

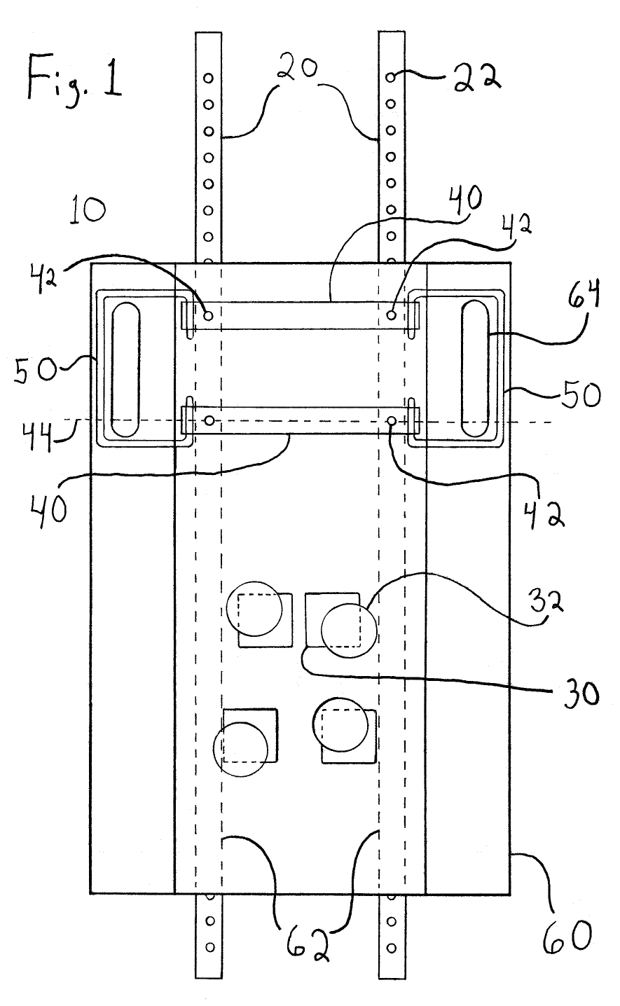

1. FIG. 1 depicts a front/top view of the massage platform assembly, according to one exemplary embodiment of this invention.

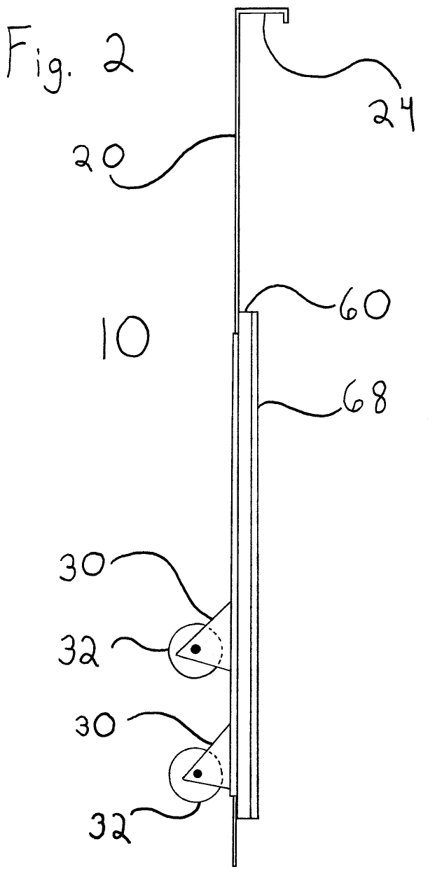

2. FIG. 2 depicts a side profile of the platform assembly.

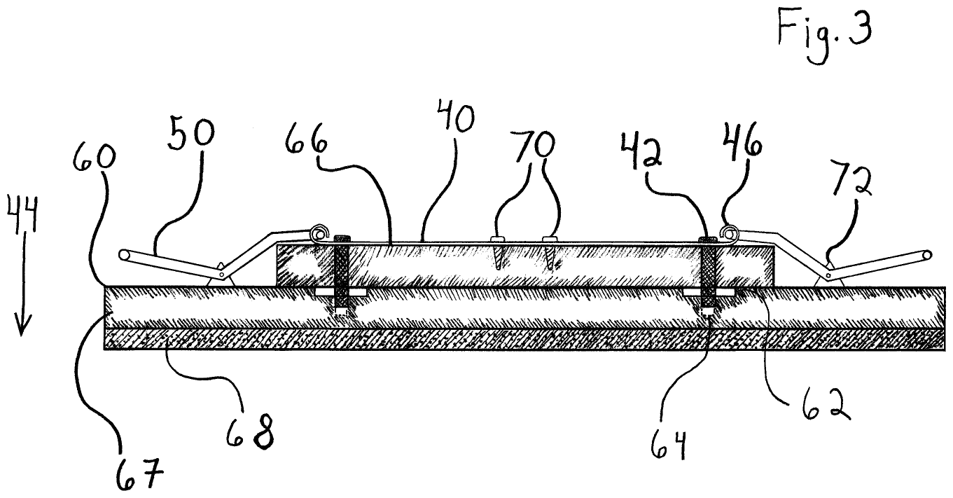

3. FIG. 3 depicts a cross section detailing flat spring, locking pins, hanger rods, release handles and primary platform layers.

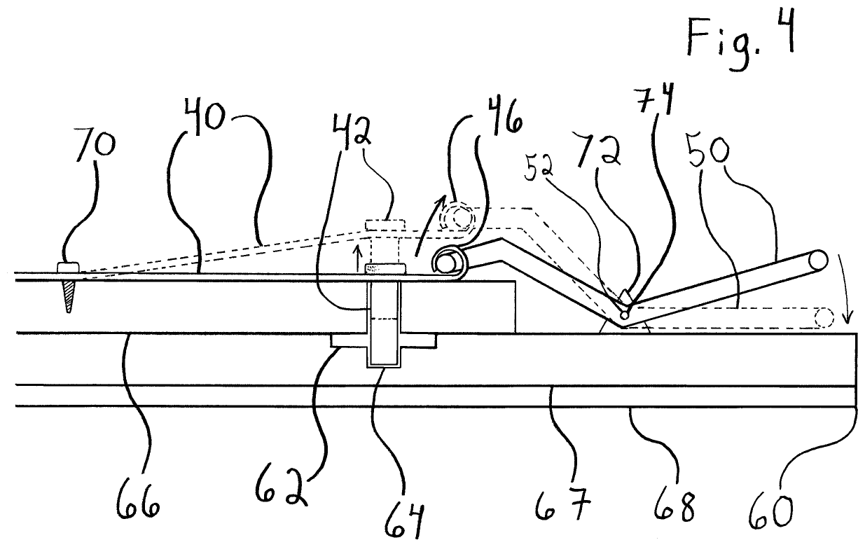

4. FIG. 4 depicts one half of the cross section to more clearly detail flat spring, locking pins and release handle assemblies in primary locked position and secondary unlocked position.

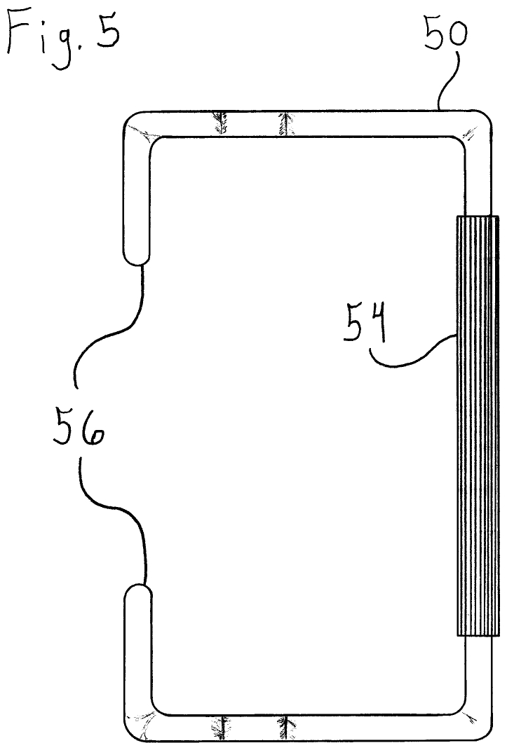

5. FIG. 5 depicts release handle from the front/top view.

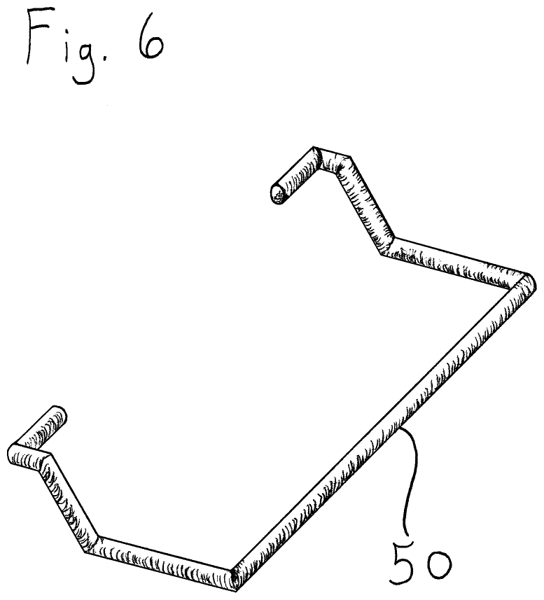

6. FIG. 6 depicts release handle in isometric view.

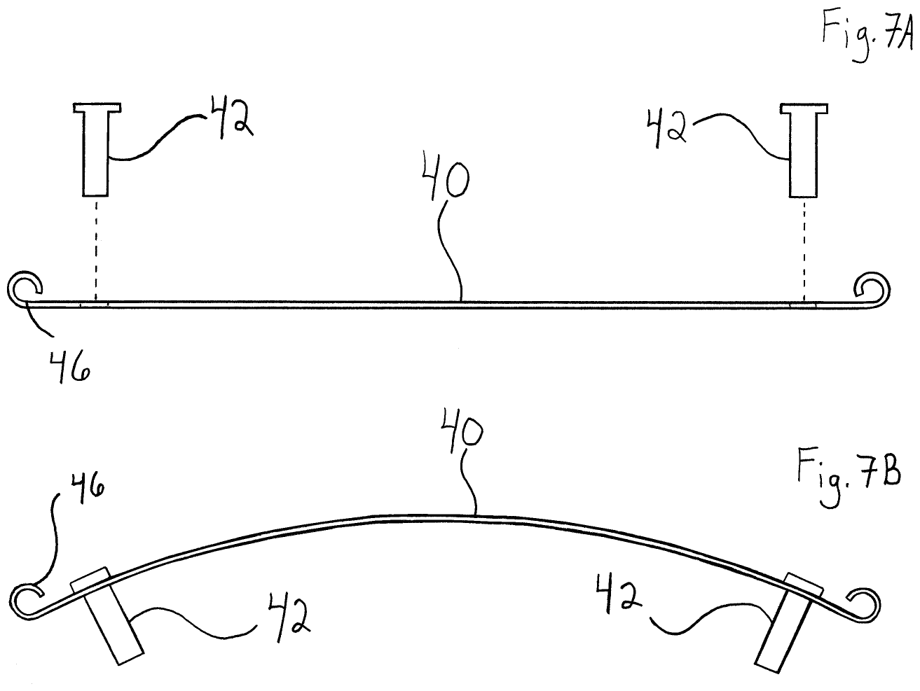

7. FIG. 7A depicts flat spring and locking pins in an exploded view. FIG. 7B depicts preloaded flat spring with locking pins attached.

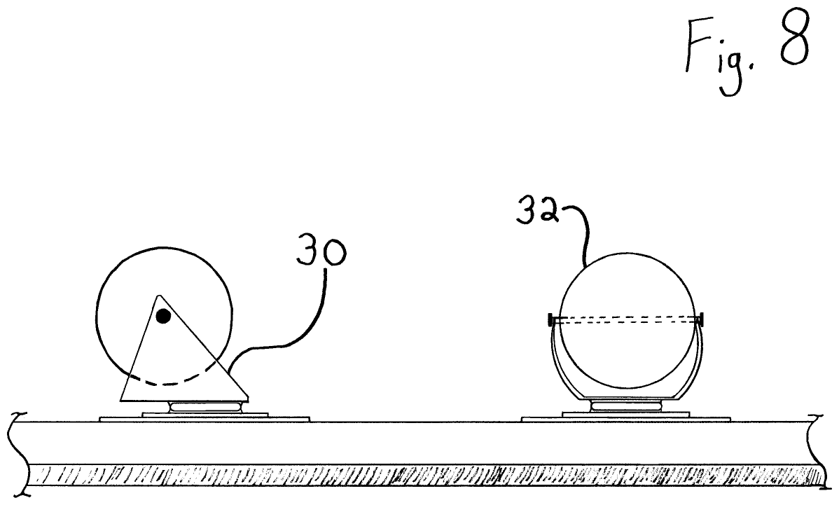

8. FIG. 8 depicts a partial cutaway section of the platform with two swivel caster massage rollers in two possible positions.

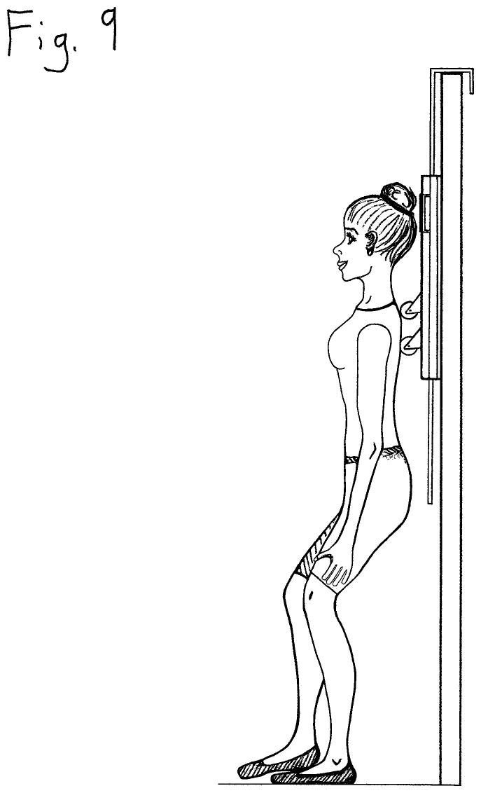

9. FIG. 9 is a side profile illustration of platform assembly in use by an individual.

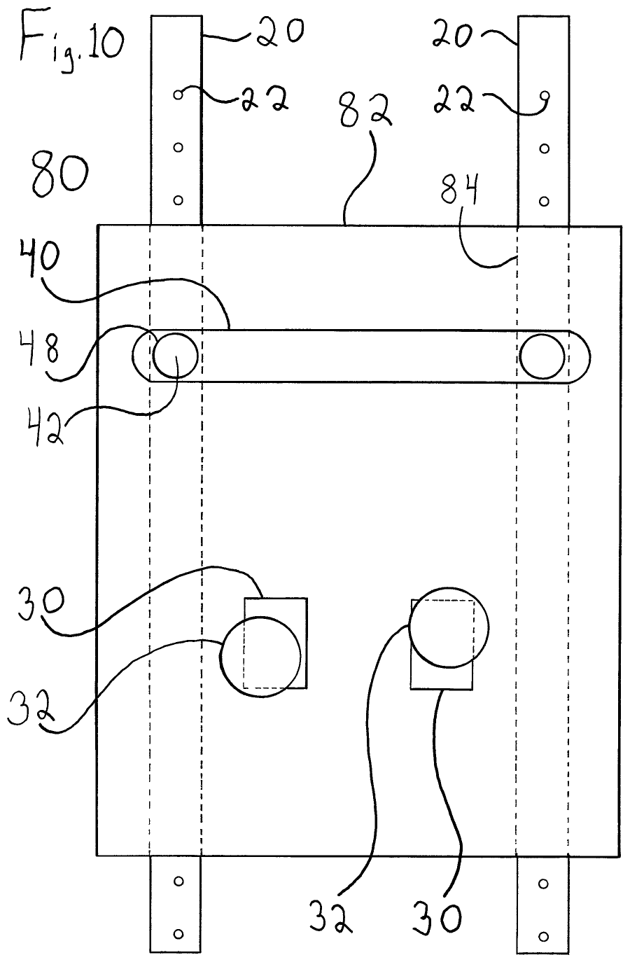

10. FIG. 10 is a illustration of an alternative, more compact version of the invention.

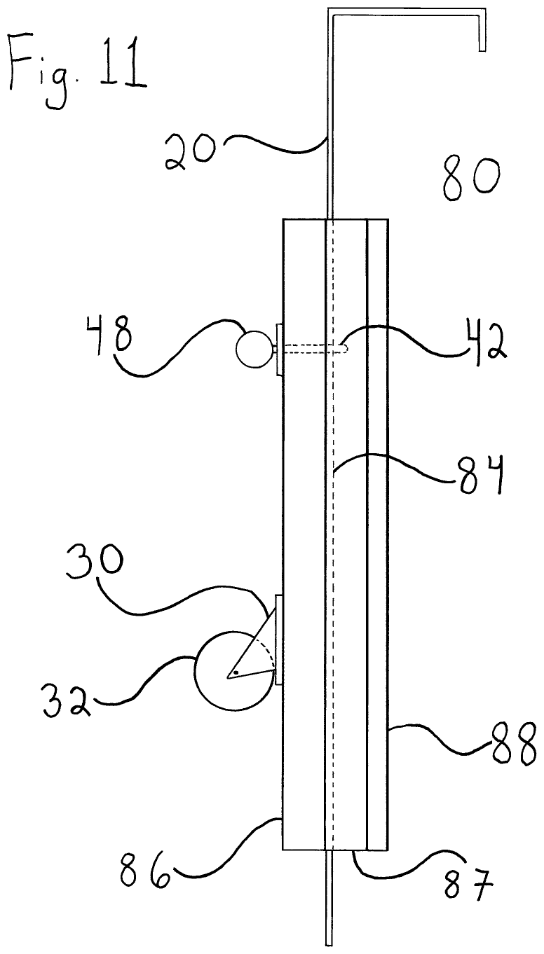

11. FIG. 11 is a side profile view of the alternative, more compact version of the invention.

### DETAILED DESCRIPTION OF THE SPECIFIED EMBODIMENTS

Referring to the Figures, wherein like numerals indicate like or corresponding parts throughout the several views, FIGS. 1-2 depict a platform assembly, generally shown at 10, according to one exemplary embodiment of this invention. FIG. 3 depicts a cross section detailing flat spring 40, locking pins 42, hanger rods 20, release handles 50 and primary platform layers 66, 67, 68. FIG. 4 depicts one half of the cross section to more clearly detail flat spring 40, locking pins 42 and release handle 50 assemblies in primary locked position and secondary unlocked position. FIG. 5 depicts release handle 50 from the front view. FIG. 6 depicts release handle 50 in isometric view. FIG. 7A depicts flat spring 40 and locking pins 42 in an exploded view. FIG. 7B depicts preloaded flat spring 40 with locking pins 42 attached. FIG. 8 depicts a partial cutaway section of the platform with two swivel casters 30 and massage rollers 32, in two possible positions. FIG. 9 is a side profile illustration of platform assembly 10 in use by an individual. FIG. 10 is a illustration of an alternative, more compact version of the invention. FIG. 11 is a side profile view of the alternative, more compact version of the invention.

The front view in FIG. 1 depicts the front view of a specified embodiment of the invention, namely a platform assembly 10 with illustration of hanger rods 20, swiveling casters 30, flat springs 40 with locking pins 42, release handles 50, primary platform 60 with hanger rod slots 62 in x-ray view. This diagram is one preferred implementation of many possible implementations of the above described invention. The hanger rods 20 are designed to fit over the top of a typical household door with platform assembly 10 facing the user when the door is closed. In this configuration, the release handles 50 can be pushed toward the primary platform 60, which forces the flat springs 40 away from the primary platform 60, causing the locking pins 42 to move upward in the pin holes in the primary platform 64 and out of the pin holes 22 in the hanger rods 20, freeing the primary platform 60 to slide up or down vertically along the hanger rods 20. When pressure is removed from the release handles 50, the flat springs 40 return to their original position, pushing the locking pins 42 back into hanger rod 20 pin holes 22, thereby locking the primary platform 60 at the desired height. Note that while this the specified embodiment, this invention is not restricted to this specific method of locking the the primary platform 10 at the desired height. The adjustable height allows the user to adjust the height of the swiveling casters 30 off the floor enabling the massage rollers 32 to contact the user's back, neck or other body area at the desired level. The user can then lean against the massage rollers 32 and then move up and down vertically, or side to side horizontally, to massage the desired area. This process can be quickly and easily repeated to accommodate different areas of the body, or different users, by changing the height off the floor of the primary platform 60. In the specified embodiment there are four swivel casters 30 with the upper pair mounted closer together than the lower pair. Thus the upper pair is mounted in such a fashion such that the massage rollers 32 can fit between the shoulder blades of most people, whereas the lower pair is mounted such that the massage rollers 32 are about 60% further apart than the upper pair. This is not necessary in general, however we claim this offers superior functionality in addressing more areas of muscle tension, and does so without adding any cost. The invention is not restricted to this layout for the swiveling casters 30, and there may be other layouts that function just as well. The hand grip holes 64 in the primary platform 60 can be used to enhance control while depressing the release handles 50 when adjusting the height of the primary platform 60. It should be noted that in this specified embodiment if pressure is accidentally removed from the release handles 50, as in the case that the user loses grip on the release handles, the flat springs 40 will automatically force the locking pins 42 into the pin holes 22 preventing the primary platform 60 from dropping uncontrollably. This feature is one that makes the specified embodiment more usable for those with limiting injuries or handicaps. Furthermore, a user with limiting injuries or handicaps to their hands or arms can easily depress the release handles 50 and adjust the height of the primary platform 60 off the floor with no assistance. In particular, the type of injuries or handicaps taken into consideration here are an individual missing one or both hands, an individual with a rotator cuff injury, an individual with cervical injuries; that is, in general most upper body injuries or handicaps so long as the individual is able to stand or walk independently.

A side profile of the platform assembly 10 is shown in FIG. 2 providing a better view of the flat hooks 24 of the hanger rods 20. These flat hooks 24 are designed to go over the top of a typical household door, and to remain in place when the door is closed. This is not required, and the invention is not restricted to this implementation, but it is a useful feature. It should also be noted that the hanger rods in this specified embodiment are made of flat material, thus are low profile and are also designed to not interfere with proper closing of the door when in place. FIG. 2 provides a view of the different layers of the primary platform 60, including the backing material 68—an optional but desirable feature, and thus included in this specified embodiment. The backing material 68 in this specified embodiment is a type of non-slip, non-marking foam that prevents damage to the door on which the primary platform 60 is supported as well as preventing the primary platform 60 from shifting or slipping during use. FIG. 2 also provides a side view of the swiveling casters 30 in resting position, and how these protrude from the primary platform 60 allowing the user to lean against massage rollers 32 while moving up and down vertically or side to side horizontally.

FIG. 3 depicts a cross section of the platform assembly 10 along the centerline 44 of the lower flat spring 40 looking toward the bottom of the primary platform 60. This enables higher detail of the three layers of the primary platform 60, including the hanger rod slots 62, the pin holes in the primary platform 64, the upper layer 66, the lower layer 67 and the backing material 68. In this implementation the hanger rod slots 62 consist of a slot cut into the lower layer 67. The upper layer 66 is fused to the lower layer 67 in a fashion such as, but limited to, adhesive, screws, welding or other fusing method. The backing material 68 is also fused to the lower layer in a similar fashion. FIG. 3 shows how the flat springs 40 are attached to the upper layer 66 with two fastening screws 70, with the two fastening screws 70 attaching the flat spring 40 at it's center allowing free movement of the extreme ends of the flat spring 40 where the release handles 50 attach through the flat spring 40 curled end 46. This view also details how the locking pins 42 extend into the primary platform 60 through the pin holes 64 in the primary platform 60 and through the pin holes 22 in the hanger rod, thus locking the primary platform 60 in place. Also detailed in FIG. 3 is the placement of the hinge assemblies 72 for the release handles 50, as well as a side profile of the release handles 50 showing how they are bent and angled to provide easy use while maintaining a lower physical profile. Note that this is one possible implementation of this mechanism, which could alternately be accomplished with different types and or placement of springs, handles, attachments, locking pins, locking mechanisms, etc.

A partial view of the cross section of the primary platform 10 along centerline 44 is shown in FIG. 4, showing the right half of the view from the top, but with the hanger rod 20 removed to enable clear views of the other components. This allows a more detailed view of the flat springs 40 with locking pins 42, release handles 50, primary platform 60 with hanger rod slots 62 as well as the pin holes in the primary platform 64, the upper layer 66, the lower layer 67 and the backing material 68. Also, it provides a more detailed view of the extreme end of the flat spring 40 where the release handle 50 attaches, how the locking pins 42 extend into the primary platform 60 through the pin holes 64 in the primary platform 60 and through the pin holes 22 in the hanger rod. Most importantly, FIG. 4 clearly details the function of the release handles 50, the flat springs 40 and the locking pins 42 during operation of the release handle 50 assembly. It details how the flat springs 40 lift the locking pins 42 inside the pin holes 64 in the primary platform 60 to clear the pin holes 22 in the hanger rods 20 (not shown) when the release handle 50 is pressed toward the primary platform 60 during operation. Another component more clearly shown in FIG. 4 is the hinge assembly 72 with the hinge pin 74 and hinge pin hole 52 in the release handle 50.

This detail of operation presented in FIG. 4 suggests alternative solutions for the flat spring/locking pin/release handle assembly. For instance, one could forgo the release handle 50 assembly and simply put a knob at the end of the flat springs 40 near or directly above the locking pins 42. One would then pull on the knob to lift the locking pin 42 outward in the pin holes through the primary platform 64, thus clearing the pin holes 22 in the hanger rod, allowing the primary platform 60 to move freely. This solution could be further modified by only using two swiveling casters 30 and using only one flat spring 40 with a locking pin 42 on each end. This solution would be much lighter and cheaper. Of course, this alternative solution would be easier to manufacture; however, the reason this is not presented as the specified embodiment is that it reduces the usefulness of the device for those with physical restrictions or handicaps. That said, the alternative solution presented here in the previous sentences will likely be produced by the manufacturer of this invention as a lighter, more compact and more portable version compared to the “specified embodiment”, as such an alternative solution will likely be preferred by some people. This alternative solution is just one possibility and the invention described is certainly not restricted to this modification as the only possible alternative solution.

FIG. 5 is a top view of the release handle 50, presenting a top view of the geometry of the release handle 50. It also shows a possible grip 54 on a section of the release handle 50. This grip 54 should be made of a non-slip comfortable material in a compact form, such as, but not limited to, rubber or silicone rubber wrapping material with grip enhancing texture. Additionally, FIG. 5 shows a top view the section 56 of the release handle 50 that will go inside curled end 46 of the flat spring 40.

FIG. 6 is an isometric view of the release handle 50. This presents the release handle 50 in a “3-D” view to more clearly demonstrate the geometry of said release handle 50. As noted earlier, this is one specified embodiment of the invention and thus the embodiment is not limited to this handle design, with a large number of possible alternatives.

FIGS. 7A and 7B show two similar view of the flat springs 40. FIG. 7A shows an exploded view of the flat spring 40 with the locking pins 42 and how they relate to each other. FIG. 7B shows an example how the flat springs 40 can be bent to create additional tension for the additional holding power to keep the locking pins 42 in place.

FIG. 8 is a close up view of the swiveling casters 30, and two possible positions of the massage rollers 32 as they pivot around their vertical axis. Swiveling casters 30 are preferred, though not required, as they enable users to massage more areas with more effectiveness as the massage rollers 32 swivels around to follow the users movement. In the specified embodiment there are four swivel casters 30 with the upper pair mounted closer together than the lower pair, as noted in section [0015] and as seen in FIG. 1. Thus the upper pair is mounted in such a fashion such that the massage rollers 32 can fit between the shoulder blades of most people, whereas the lower pair is mounted such that the massage rollers 32 are about 60% further apart than the upper pair. This is not necessary in general, however we claim this offers superior functionality in addressing more areas of muscle tension, and does so without adding any cost. Future models may add the option to have adjustable width mounts for the swiveling casters 30. Some of the other possible options for these is to have replaceable massage rollers 32 to accommodate users with different roller firmness preference, more than two pairs of swiveling casters 30, only one pair of swiveling casters 30, different size massage rollers 32, using devices other than swiveling casters, and other similar modifications.

FIG. 9 illustrates an example of the specified embodiment being used by an individual.

FIG. 10 illustrates the more compact version of this invention, mentioned in section [0019]. The alternate platform assembly is generally shown at 80, and the similarities and differences when compared to the platform assembly 10 of the specified embodiment are easily evident. This alternate version has a smaller primary platform 82 and two hanger rods 20 with pin holes 22, with alternate rod slots 84 (shown in x-ray). It also has three layers like the specified embodiment, with an alternate top layer 86, alternate lower layer 87 and an alternate backing material 88. However, there is only one flat spring 40, and this flat spring 40 has two pull knobs 48 directly over the locking pins 42, which are pulled to release the locking mechanism of the locking pins 42. These pull knobs 48 replace the release handles 50, making the device lighter and simpler. This solution is good for those who want a lighter more compact device, but it is less useful for individuals with certain injuries or handicaps, which is why this isn't the primary specified embodiment. Also, note there is only one pair of swiveling casters 30 and thus only two massage rollers 32, which makes this version lighter but also covers a smaller area for a given height setting.

A side profile of the alternate implementation is shown in FIG. 11, and shows the alternate top layer 86, alternate lower layer 87 and alternate backing material 88. It also better shows the pull knobs 48, and their relationship to the locking pins 42. FIG. 11 also provides an x-ray view of the locking pins 42 and an x-ray view of the alternate rod slots 84. Finally, a side profile view of the swiveling caster(s) 30 with the massage roller 32 is shown.

Those skilled in the art will appreciate that various adaptations and modifications of the just-described embodiments can be configured without departing from the Scope and Spirit of the invention. Therefore, it is to be understood that, within the Scope of the appended claims, the invention may be practiced other than as specifically described herein.

What is claimed is:

1. A massage device comprising:
a) A platform;
b) One or more massage components attached to said platform;
c) A method of attaching said platform to a wall, door or other suitable support component(s) such that the massage component(s) face away from the support component(s) in an accessible fashion;
d) A method of adjusting the position of said platform with respect to the attachment component(s) and/or the support component(s);
e) Wherein the support component(s) are not generally considered part of the massage device.

2. The device according to claim 1, wherein:
a) The method of attaching the platform comprising at least one rod or rail attached to the support component(s);
b) The platform has a slot, channel or other method of securing the platform to the rod(s) or rail(s) while allowing free movement of the platform along the rod(s) or rail(s);
c) The method of adjusting the position of the platform comprising at least a locking mechanism and a release mechanism, which may be both in one mechanism, which allows the platform to be positioned along the rod(s) or rail(s), and/or locked into place along the rod(s) or rail(s), as desired.

3. The device according to claim 2, wherein:
a) The method of attaching the platform comprising at least one or more hanger rod(s) with hook(s) at the top end allowing the entire massage device to be hung on a door or other suitable support platform.

4. The device according to claim 1, wherein:
a) The method of attaching the platform comprising a flexible member such as a strap or cord;
b) The method of adjusting the platform position either comprising adjusting the relative length's of the flexible member(s) and/or sliding the platform along the length of the flexible member(s);
c) A mechanism to lock the platform in place either by locking the platform to the flexible member(s) or locking the relative length of the flexible member(s) in place, or both.

5) A device according to claim 1, wherein:
a) The massaging components comprise four components;
b) The four components are laid out as the vertices of a quadrilateral that is not a parallelogram;
c) One pair of vertices is closer together than the other.

6) A device according to claim 5, wherein:
a) The massaging components are laid out as the vertices of a trapezoid in which two of the parallel sides of the trapezoid are parallel with the upper and/or lower sides of the platform; that is, approximately parallel with horizontal level of a standing surface such as a floor;
b) The upper pair of vertices are closer together than the lower pair of vertices, or vice versa.

7) A device according to claim 1, wherein:
a) The massage components are modeled after offset casters.

8) A device according to claim 7, wherein:
a) The massage components are replaceable.

9) A device according to claim 1, wherein:
a) The massage components are replaceable.

10) The device according to claim 2, wherein:
a) The the adjustment component(s) default to a locked position to keep the platform locked in position until the release mechanism(s) is (are) activated;
b) The release mechanism(s) require(s) positive action to remain in a released state;
c) Removing the positive action from the release mechanism(s) causes the adjustment component(s) to re-engage the locking mechanism(s);
d) The release mechanism(s) is (are) activated by pushing on a lever, handle, button, or similar mechanism.
